(19) United States
(12) Patent Application Publication
(10) Pub. No.: US 2007/0168741 A1
(43) Pub. Date: Jul. 19, 2007

(54) Method, system and program product for facilitating debugging of simulation results obtained for an optimized simulation model of a device design having hierarchically-connected components

(75) Inventors: Sundeep Chadha, Austin, TX (US); Sudhi R. Proch, Austin, TX (US)

Correspondence Address: IBM CORPORATION;DEPARTMENT 417, 3605 HIGHWAY 52 NORTH, ROCHESTER, MN, 55901-7829, US

(73) Assignee: International Business Machines Corporation, Armonk, NY (US)

(21) Appl. No.: 11/282,091

(22) Filed: Nov. 17, 2005

(51) Int. Cl. G06F 11/00

(52) U.S. Cl. 714/38

(57) ABSTRACT

A computer-implemented processing tool is provided for facilitating debugging of simulation results obtained for an optimized simulation model of a device having hierarchically-connected components. The tool includes: receiving a component port name of the device to be searched; automatically checking a hardware descriptive language description of the device for a next higher level component of the device that instantiates the component having the component port name to be searched; locating a signal name in the next higher level component that is connected to the port identified by the component port name; and outputting the signal name as a signal that drives the named component port when the signal is other than a port signal of the next higher level component. Otherwise, repeating the automatically checking and the locating when the signal name in the next higher level component is a port signal of a further higher level component.

### TECHNICAL FIELD

This invention relates generally to debugging of simulation results during device design verification, and more particularly, to a facility for debugging and tracing simulation results for an optimized simulation model of a device having hierarchically-connected components.

### BACKGROUND OF THE INVENTION

When a simulation of a device design is run during verification testing, and one or more failures in the simulation results need to be debugged or traced, it is often convenient to look at the simulation results depicted in a graphical interface as waveforms to find values of a signal(s) of interest at various times. The signal(s) of interest will almost always include a port(s) of the particular entity or component that is being examined. The task of the design/verification engineer is facilitated if the engineer is able to examine the values of the ports to a particular component, to determine what is happening inside the logic of the component. With current device designs and the simulation structures around these designs becoming ever larger, this is not always readily possible.

### SUMMARY OF THE INVENTION

One approach that a simulation model build tool can employ to limit the size of the data structures created, when compiling and building the models for the verification environment, is to collapse port nodes that are simple wire connections across hierarchical components. The model build tool in such a case preserves the final driver node only. This generally is successful since the optimized model or reduced model size increases simulation speed, in addition to saving disk space. However, such an optimized simulation model may be a problem when a failure is to be debugged that requires the component ports to be examined. This is because the ports may just be a wire connection across various levels of hierarchies, and so, could have been “dropped out” while optimizing the model. The problem is encountered with component input ports, but in certain cases may also arise with output ports.

One possible solution to the problem would be to return to the hardware descriptive language from which the optimized simulation model was compiled and build a non-optimized, exploded model, where all signal names are preserved. This is not always the best choice because of time, space and simulation speed considerations. Another solution would be for the design/verification engineer to manually trace the input ports, for example, using a text editor, through the various levels of hierarchies. This solution can be very tedious and time consuming, and is therefore generally undesirable.

Thus, there is a need in the art for an automated tool for facilitating debugging of simulation results obtained for an optimized simulation model of a device having hierarchically-connected components. The present invention is directed to meeting this need.

In accordance with an aspect of the present invention, a computer-implemented method is provided for facilitating debugging of simulation results obtained for an optimized simulation model of a device design having hierarchically-connected components. The method includes: receiving a component port name of the device design to be searched; automatically checking a hardware descriptive language description of the device design for a next higher level component of the device that instantiates the component having the component port name to be searched; locating a signal name in the next higher level component that is connected to the port identified by the component port name; and outputting the signal name as a signal that drives the named component port when the signal is other than a port signal of the next higher level component.

In another aspect, a system for facilitating debugging of simulation results obtained for an optimized simulation model of a device design having hierarchically-connected components is provided. This system includes a computer-implemented processing tool. The computer-implemented processing tool includes means for: receiving a component port name of the device design to be searched; automatically checking a hardware descriptive language description of the device design for a next higher level component of the device that instantiates the component having the component port name to be searched; locating a signal name in the next higher level component that is connected to the port identified by the component port name; and outputting the signal name as a signal that drives the named component port when the signal is other than a port signal of the next higher level component.

In a further aspect, at least one program storage device is provided readable by a computer, tangibly embodying at least one program of instructions executable by the computer, to perform a method of facilitating debugging of simulation results obtained for an optimized simulation model of a device design having hierarchically-connected components. The method includes: receiving a component port name of the device design to be searched; automatically checking a hardware descriptive language description of the device design for a next higher level component of the device that instantiates the component having the component port name to be searched; locating a signal name in the next higher level component that is connected to the port identified by the component port name; and outputting the signal name as a signal that drives the named component port when the signal is other than a port signal of the next higher level component.

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one example of a computing environment incorporating and using a facility in accordance with an aspect of the present invention;

FIG. 2 depicts one example of various components associated with an operating system of FIG. 1, and employing a facility in accordance with an aspect of the present invention;

FIG. 3 depicts one embodiment of a tool facilitating debugging of simulation results obtained for an optimized simulation model of a device having hierarchically-connected components, in accordance with an aspect of the present invention;

FIG. 4 is a flowchart of one embodiment of a process for facilitating debugging of simulation results obtained for an optimized simulation model, in accordance with an aspect of the present invention; and

FIG. 5 is an example of a device design to undergo verification simulation testing and debugging, in accordance with an aspect of the present invention, and wherein components are hierarchically-connected within the device design.

### BEST MODE FOR CARRYING OUT THE INVENTION

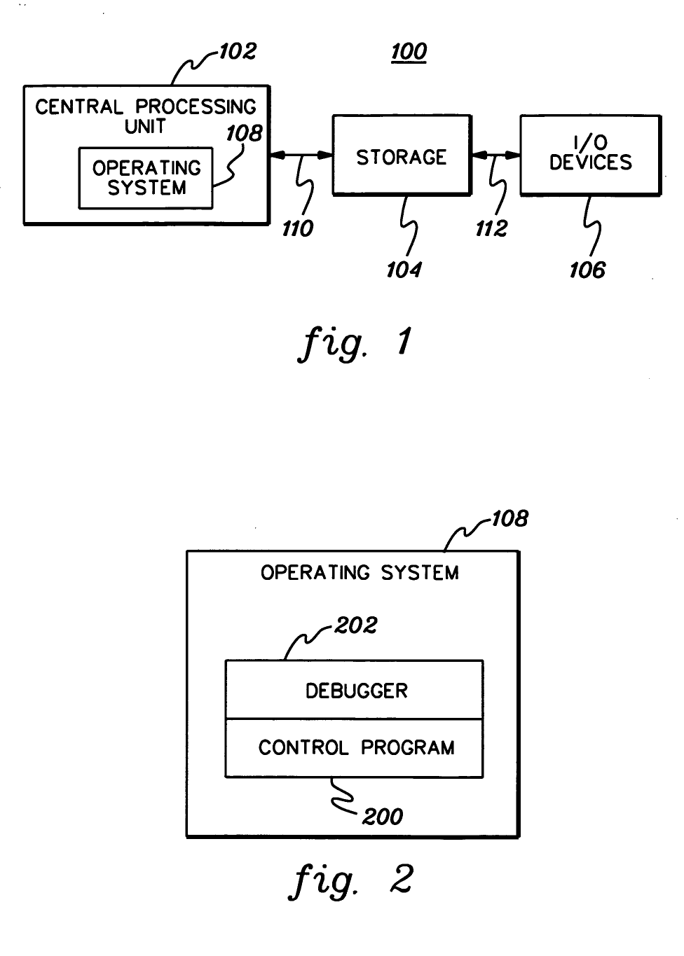

One embodiment of a computing environment incorporating and using the capabilities of the present invention is described below with reference to FIG. 1. In one example, this computing environment 100 is based on the z/Architecture, offered by International Business Machines Corporation, Armonk, New York. The z/Architecture is described in an IBM publication entitled “Z/Architecture Principles of Operation”, Publication No. SA22-7832-01, October 2001, which is hereby incorporated herein by reference in its entirety.

Computing environment 100 includes, for instance, one or more central processing units (CPUs) 102, storage 104 and one or more input/output devices 106. Each of these components is well known to those skilled in the art.

Briefly, central processing unit 102 contains the sequencing and processing facilities for instruction execution, interruption action, timing functions, initial program loading, and other machine related functions. In one embodiment, central processing unit 102 executes an operating system 108, such as, for instance, the AIX operating system offered by International Business Machines Corporation.

Central processing unit 102 is coupled via, for example, a bidirectional bus 110, to storage 104. Storage 104 is, for instance, directly addressable and provides for high-speed processing of data by the central processing unit(s). Storage 104 can be physically integrated with the CPU(s) or constructed as stand alone units.

Storage 104 is further coupled via, for instance, a bidirectional bus 112, to input/output devices 106. Input/output devices 106 may include, for instance, printers, magnetic tape units, direct access storage devices (DASD), displays, keyboards, communication controllers, teleprocessing devices and optical and sensor based equipment. Data is transferred from storage 104 to I/O devices 106 and from the I/O devices back to storage via known input/output commands.

The above-described computing environment is only one example. The capabilities of the present invention can be used with many other computing environments without departing from the spirit of the present invention. For example, the capabilities of the present invention could be used with AIX, UNIX or other systems.

Further details of operating system 108 are described with reference to FIG. 2. In one example, operating system 108 includes a control program 200, which performs many of the control functions associated with an operating system. Coupled to control program 200 is at least one debugger 202. A debugger can be implemented in software, hardware, microcode or any combination thereof. In one embodiment, debugger 202 may be packaged with the TPF operating system of International Business Machines Corporation. Debugger 202 includes logic for facilitating debugging of simulation results obtained for an optimized simulation model of a device design undergoing verification testing in accordance with aspects of the present invention. Although the debugger is shown as part of the operating system, this is not necessary. A portion or all of the debugger may be separate from the operating system. Further, operating system 100 may include various other programs/tools that need not be described for the various aspects of the present invention.

More specific to the present invention, provided herein is a computer-implemented tool for facilitating debugging of simulation results obtained for an optimized simulation model of a device having hierarchically-connected components. As used herein, an “optimized simulation mode” refers to any simulation model which has been optimized through a condensing or truncation of one or more features of the device. By way of example, a simulation model is discussed herein wherein one or more ports (or port nets) of a component of the device have been “dropped out” while optimizing the model. That is, any port or port net that is a simple wire connection across various levels of hierarchies is condensed and dropped out (or truncated) in the optimized simulation model. Thus, internal signal line names of the device are removed where no functional logic is occurring on the signal line and where the signal line directly connects between ports of multiple levels of components within the device. Further, a “component” refers to any logic block or entity within a device design, while a “device” refers to any circuit layout, integrated circuit chip, etc. undergoing verification testing via simulation.

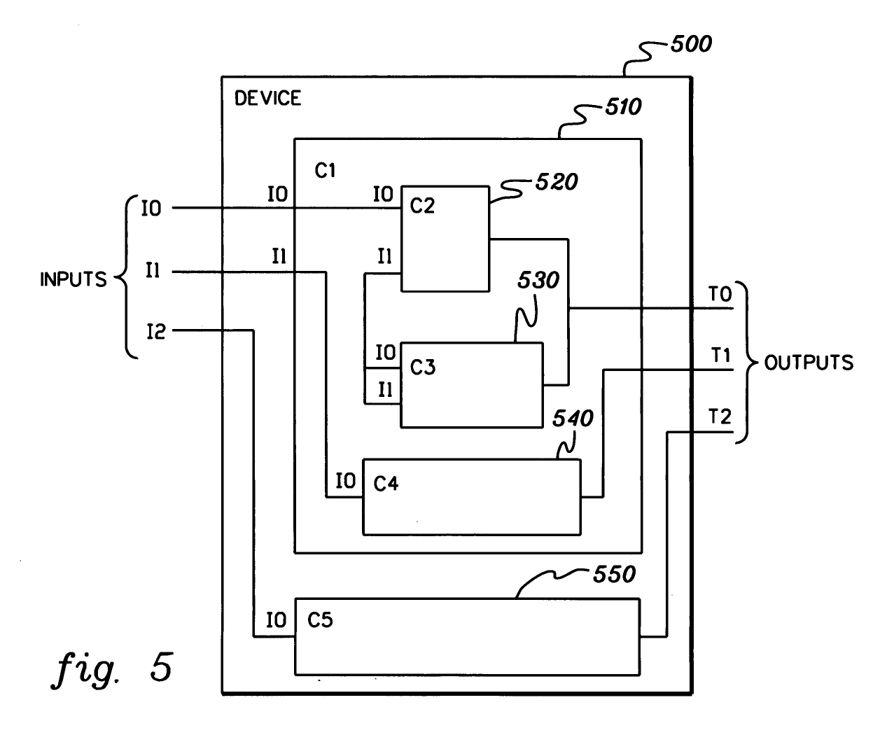

In one implementation, the tool can comprise a simple command line-based facility that automatically traverses the hierarchies in a hardware descriptive language document for the device design to locate a last driver node or port that drives the port of the specific component of interest. Note again that this description assumes that the device comprises a plurality of components which are hierarchically-connected within the device design. One example of such a structure is depicted in FIG. 5, and described further below.

In one aspect, a tool for facilitating debugging in accordance with the present invention employs a pattern match engine at its core. One or more component ports of interest is identified, for example, in a hierarchical name format, as an input to the tool. The tool then commences looking for the drive node/port in the design file that corresponds to the lowest level in the hierarchy for the given component port. If the tool is unable to locate the driver node in the current design file or level, then it moves up the hierarchy chain and tries to find the driver node in the design file corresponding to the next hierarchy level. The tool stops if the driver node is found in the current design file, otherwise it continues with the bottom-up approach, moving up in the hierarchy one step at a time and traversing across multiple design files until it finds the driver node/port corresponding to the given component port to be searched.

Once the drive port is found, the information is provided back (e.g., displayed) to the user and the process is terminated. This driver port name is the signal name “preserved” by the model build tool, and directly corresponds to the component port of interest. The user can then employ this driver port name in the debugging tool to obtain relevant information about the component port of interest.

One advantage of a facility as described herein is that it does not require a change in the current flow of model build processing, and does not force a non-optimized model build which, as mentioned above, is machine time, storage space and verification run-time performance non-optimal. A further advantage is that the tool makes unnecessary the often tedious effort required on the part of a design/verification engineer to go through multiple design files in order to manually ascertain a driver node of interest. Further, the tool described hereinbelow can be expanded to integrate with, for example, a waveform viewer, and/or source code viewer, or other debugger, so that the user does not have to go to a command line and execute the tool separately. Integrating the tool with the waveform viewer, for example, can enable a user to simply type in the name of the component and the port name of interest, and the tool can execute behind the covers (transparently) to ascertain the name of the driver node/port of interest. The driver node can then be easily displayed by a click of a button rather than going back to the waveform viewer and typing the name of the driver node.

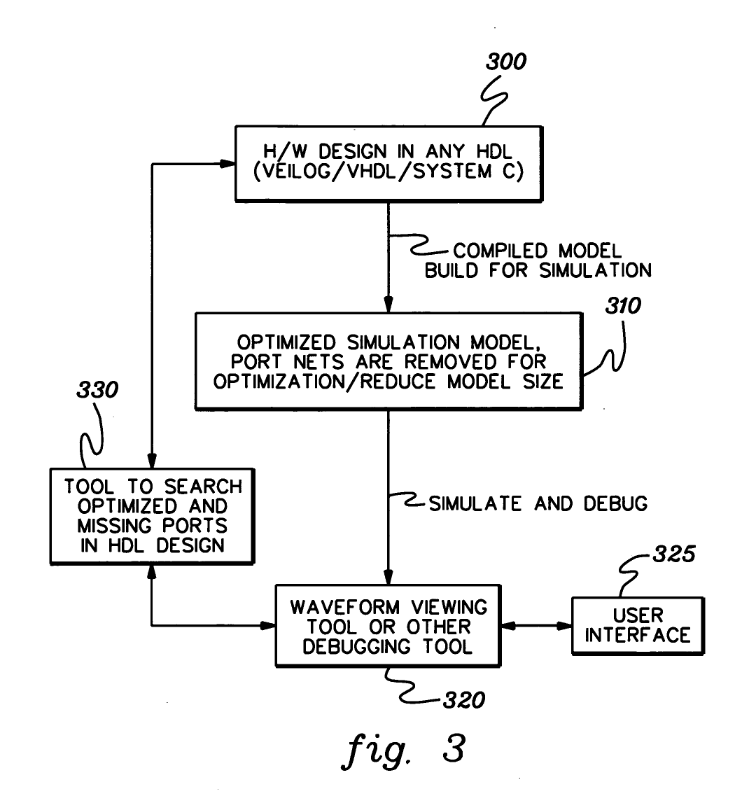

FIG. 3 depicts one example of a simulation and debugging environment employing a tool for facilitating debugging, in accordance with an aspect of the present invention. As shown, a hardware design for a device in any standard hardware descriptive language (HDL), such as Verilog, VHDL, or System C, is provided 300. From this hardware descriptive language, a simulation model is compiled into a database that is understood by a simulator. A compiler is typically designed for a particular simulator in order to construct a database in a format that the simulator understands. The concepts presented herein are not dependent on the type of compiler or simulator employed, however. There are many industry standard compilers and simulators with which the tool can be used.

Device modeling or simulation is well known in the art. For example, component design text or graphics may initially be generated in HDL to include system information, a processor core, custom logic or ASICs, and memory. This design information is then converted to a net list and the net list is converted to a simulation model in a manner understood by one skilled in the art. The resulting simulation model is then employed within a simulator as will be apparent to one skilled in the art.

An accurate cycle simulation model is discussed in detail in an article by Hallock et al. entitled “SIM API—A Common Programming Interface For Simulation,” IBM J. Res. Develp. Vol. 41, No. 4/5 (July/September 1997), which is hereby incorporated herein by reference in its entirety. Further, various accurate cycle simulators are commercially available, for example, reference the SpeedSim™ cycle simulator marketed by Quick Turn Design Systems of San Jose, Calif., the Cobra™ cycle simulator marketed by Cadence Design Systems of San Jose, Calif. and the Cyclone™ UHDL cycle simulator marketed by Synopsys of Mountain View, Calif. In addition to cycle simulators, Cadence Design Systems market event simulators, such as Verilog-XL, NC Verilog, and NC VHDL, while Synopsys markets a VCS event simulator. Those skilled in the art will understand that the cycle and event simulators referenced herein are provided by way of example only. The tool described herein can be employed with any commercially available simulator and associated compiler.

Significant to the invention, however, is the concept that the simulation model is optimized, with selected port nets having been removed for optimization/reduction of the model build size 310 as described above. Once the optimized simulation model is obtained, the simulator can employ the model to perform verification testing of the device design using selected test cases or vectors. If one or more of the simulation results is other than expected, the results can be debugged or traced in order to ascertain where there may be a problem with the device design. Again, simulation testing and debugging are well-known concepts to those skilled in the art. The simulation results can be displayed via a waveform viewing tool or other debugging tool 320. Examples of waveform viewers are the Debussy system available from Novas of San Jose, Calif., and the Simwave tool available from Cadence Design Systems of San Jose, Calif. A user interface 325 allows a user to, for example, view the simulation results employing the waveform viewing tool. Further, user interface 325 allows a user to input requests for information from the debugging tool, for example, to search for a driver node for a component port of interest. Assuming that the component port of interest was optimized out during construction of the optimized simulation model, then the waveform viewing tool or other debugging tool will be unable to provide the user with the requested information. Thus, presented herein is an automated tool for facilitating searching of the device design in the hardware descriptive language to locate optimized out or other missing ports in the simulation model of the design 330.

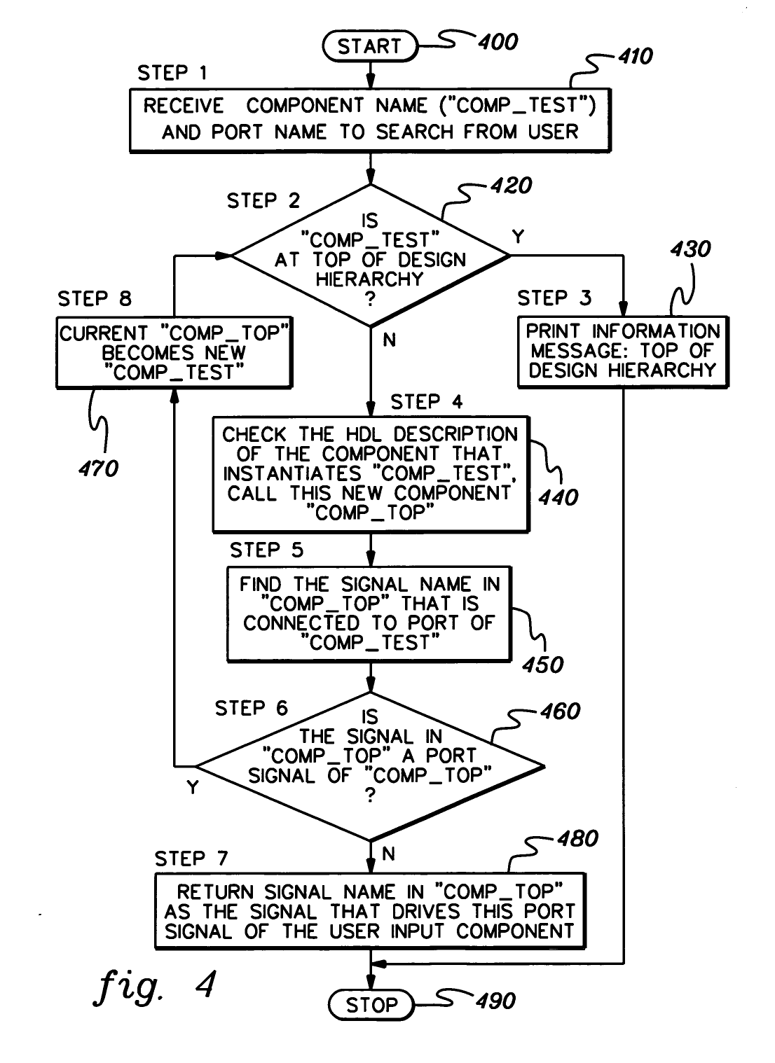

FIG. 4 depicts one embodiment of processing implemented by tool 330. In this embodiment, the tool begins processing 400 with receipt of a component name (“comp_test”) and a port name to search from a user, for example, who is debugging simulation results 410. The tool determines whether this component name (“comp_test”) is at the top most level of the device design hierarchy 420. If “yes”, then the tool is finished and an information message is returned to the user that the component port of interest is at the top of the design hierarchy, i.e., at the device port level 430.

Assuming that the named component is other than at the top of the design hierarchy, then the tool checks the hardware descriptive language description of the component that instantiates the named component (i.e., “comp_test”). This new component is referred to as “comp_top” 440. The signal name in this current higher level component (“comp_top”) that is connected to the named port of interest of “comp_test” is then found 450. The tool determines whether this signal in the current higher level component “comp_top” is itself a port signal of the higher level component 460, and if so, then the current higher level component “comp_top” becomes the new test component “comp_test” 470, and the processing repeats with an inquiry into whether this new test component is at the top of the device design hierarchy 420.

Assuming that the signal identified in inquiry 460 is an internal signal to the current higher level component “comp_top”, then this internal signal name is returned as the signal that drives the port signal of the user inputted component name 480, which completes processing of the tool 490.

FIG. 5 depicts one example of a device design 500 having a plurality of hierarchically-connected components. The device (e.g., chip) is the top most level of a digital design which is being simulated. The components instantiated in the design (or the logical functional blocks that make up the design) are labeled component C1 510, component C2 520, component C3 530, component C4 540, and component C5 550. Components C2, C3 & C4 are instantiated by component C1. Both device and instantiated components have a set of input ports (labeled I0, I1, I2, etc.) and a set of output ports (labeled T0, T1, T2, etc.). Interconnecting wires or signal lines are shown between the various ports of the device.

Two tool processing examples employing the device design of FIG. 5, and illustrating the processing of FIG. 4 are presented below for completeness.

### EXAMPLE 1

Assume that the user wants to know the state of port I0 of component C2. A full hierarchy component port name is provided as “device.C1.C2.I0”. Referencing the flowchart of FIG. 4, the following steps are involved:

Step 1: User inputs the port name and component name of interest, named “comp_test”=“device.C1.C2.I0”.
Step 2: “comp_test” is not at top of design hierarchy. Go to Step 4.
Step 4: Component that instantiated C2 is C1, “comp_top” 32 C1. Go to Step 5.
Step 5: Checking the HDL description of C1, shows that port I0 of C2 is directly connected to port I0 of C1. Go to Step 6.
Step 6: Port I0 of C2 is connected to port name 10 of C1. Go to Step 8.
Step 8: New “comp_test” 32 C1. Go to Step 2.
Step 2: This “comp_test” (C1) is also not at top of design hierarchy. Go to Step 4.
Step 4: Component that instantiated C1 is the device, “comp_top”=device. Go to Step 5.
Step 5: Checking the HDL description of the device, shows that port I0 of C1 is directly connected to port I0 of the device. Go to Step 6.
Step 6: Port I0 of C1 is connected to port name I0 of the device. Go to Step 8.
Step 8: New “comp_test”=device. Go to Step 2.
Step 2: This “comp_test” (device) is at the top of the design hierarchy. Go to Step 3.
Stop: Return device port I0 as final result and stop.

### EXAMPLE 2

Assume that the user wants to know the state of port I1 of component C2. A full hierarchy component port name is provided as “device.C1.C2.I1”. Again referencing the flowchart of FIG. 4, the following steps are involved:

Step 1: User inputs the port name and component name of interest, named “comp_test” 32 “device.C1.C2.I1”.
Step 2: “comp_test” is not at top of design hierarchy. Go to step 4.
Step 4: Component that instantiated C2 is C1, “comp_top”=C1. Go to step 5.
Step 5: Checking the HDL description of C1, shows that port I1 of C2 is directly connected to port I0 of C3. Go to step 6.
Step 6: Port I1 of C2 is connected to port named I0 of C3. This wire (which connects port I1 of C2 with port 10 of C3) is an internal signal of C1. Go to step 7.
Step 7: Return signal in C1 that connects port I1 of C2 and port 10 of C3 as the driver of the user initiated port search.
Stop.

The detailed description presented above is discussed in terms of program procedures executed on a computer or network of computers. These procedural descriptions and representations are the means used by those skilled in the art to most effectively convey the substance of their work to others skilled in the art. They may be implemented in hardware or software, or a combination of the two.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or similar devices.

Each step of the method may be executed on any general computer, such as a mainframe computer, personal computer or the like and pursuant to one or more, or a part of one or more, program modules or objects generated from any programming language, such as C++, Java, Fortran or the like. And still further, each step, or a file or object or the like implementing each step, may be executed by special purpose hardware or a circuit module designed for that purpose.

In the case of diagrams depicted herein, they are provided by way of example. There may be variations to these diagrams or the steps (or operations) described herein without departing from the spirit of the invention. For instance, in certain cases, the steps may be performed in differing order, or steps may be added, deleted or modified. All of these variations are considered to comprise part of the present invention as recited in the appended claims.

The invention is preferably implemented in a high level procedural or object-oriented programming language to communicate with a computer. However, the invention can be implemented in assembly or machine language, if desired. In any case, the language may be a compiled or interpreted language.

The invention may be implemented as a mechanism or a computer program product comprising a recording medium. Such a mechanism or computer program product may include, but is not limited to CD-ROMs, diskettes, tapes, hard drives, computer RAM or ROM and/or the electronic, magnetic, optical, biological or other similar embodiment of the program. Indeed, the mechanism or computer program product may include any solid or fluid transmission medium, magnetic or optical, or the like, for storing or transmitting signals readable by a machine for controlling the operation of a general or special purpose programmable computer according to the method of the invention and/or to structure its components in accordance with a system of the invention.

The invention may also be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another apparatus (such the electronic test equipment). The system may be specially constructed for the required purposes to perform, for example, the method steps of the invention or it may comprise one or more general purpose computers as selectively activated or reconfigured by a computer program in accordance with the teachings herein stored in the computer(s). The procedures presented herein are not inherently related to a particular computer system or other apparatus. The required structure for a variety of these systems will appear from the description given.

Again, the capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A computer-implemented method of facilitating debugging of simulation results obtained for an optimized simulation model of a device design having hierarchically-connected components, the method comprising:
receiving a component port name of the device design to be searched;
automatically checking a hardware descriptive language description of the device design for a next higher level component of the device that instantiates the component having the component port name to be searched;
locating a signal name in the next higher level component that is connected to the port identified by the component port name; and
outputting the signal name as a signal that drives the named component port when the signal is other than a port signal of the next higher level component.

2. The method of claim 1, wherein the component port name comprises a hierarchical component name identifying a hierarchical location within the device of the component having the component port name to be searched.

3. The method of claim 1, wherein the simulation results being debugged result from simulation testing of the optimized simulation model, and wherein the optimized simulation model was optimized by removing an internal signal line of the device where no functional logic occurs and where the signal line directly connects a port of one component to a port of a higher level component.

4. The method of claim 1, further comprising determining whether the signal name in the next higher level component identified by the locating is a port signal of a further higher level component from the next higher level component, and if so, repeating the automatically checking, and the locating employing the port signal of the next higher level component as the component port name to be searched.

5. The method of claim 1, further comprising determining whether the component having the component port name to be searched is a component at a top most level of the hierarchically-connected components of the device, and if so, indicating that the component port name to be searched is or is connected to a top most level component port of the device and discontinuing the automatically checking, the locating and the outputting for the component port name to be searched.

6. The method of claim 1, wherein the method is implemented within a computer processing tool coupled to a debugging tool or waveform viewing tool, and wherein the receiving comprises receiving the component port name to be searched at the computer processing tool via the debugging tool or waveform viewing tool.

7. The method of claim 6, wherein the component port name to be searched is selected by a user of the debugging tool or waveform viewing tool.

8. A system for facilitating debugging of simulation results obtained for an optimized simulation model of a device design having hierarchically-connected components, the system comprising:
a computer-implemented processing tool, the computer-implemented processing tool comprising means for:
receiving a component port name of the device design to be searched;
automatically checking a hardware descriptive language description of the device design for a next higher level component of the device that instantiates the component having the component port name to be searched;
locating a signal name in the next higher level component that is connected to the port identified by the component port name; and
outputting the signal name as a signal that drives the named component port when the signal is other than a port signal of the next higher level component.

9. The system of claim 8, wherein the component port name comprises a hierarchical component name identifying a hierarchical location within the device of the component having the component port name to be searched.

10. The system of claim 8, wherein the simulation results being debugged result from simulation testing of the optimized simulation model, and wherein the optimized simulation model was optimized by removing an internal signal line of the device where no functional logic occurs and where the signal line directly connects a port of one component to a port of a higher level component.

11. The system of claim 8, wherein the computer-implemented processing tool further comprises means for determining whether the signal name in the next higher level component identified by the locating is a port signal of a further higher level component from the next higher level component, and if so, for repeating the automatically checking, and the locating employing the port signal of the next higher level component as the component port name to be searched.

12. The system of claim 8, wherein the computer-implemented processing tool further comprises means for determining whether the component having the component port name to be searched is a component at a top most level of the hierarchically-connected components of the device, and if so, for indicating that the component port name to be searched is or is connected to a top most level component port of the device and for discontinuing the automatically checking, the locating and the outputting for the component port name to be searched.

13. The system of claim 8, wherein the means for receiving comprises means for receiving the component port name to be searched at the computer-implemented processing tool via a debugging tool or waveform viewing tool.

14. At least one program storage device readable by a computer, tangibly embodying at least one program of instructions executable by the computer, to perform a method of facilitating debugging of simulation results obtained for an optimized simulation model of a device design having hierarchically-connected components, the method comprising:
receiving a component port name of the device design to be searched;
automatically checking a hardware descriptive language description of the device design for a next higher level component of the device that instantiates the component having the component port name to be searched;
locating a signal name in the next higher level component that is connected to the port identified by the component port name; and
outputting the signal name as a signal that drives the named component port when the signal is other than a port signal of the next higher level component.

15. The at least one program storage device of claim 14, wherein the component port name comprises a hierarchical component name identifying a hierarchical location within the device of the component having the component port name to be searched.

16. The at least one program storage device of claim 14, wherein the simulation results being debugged result from simulation testing of the optimized simulation model, and wherein the optimized simulation model was optimized by removing an internal signal line of the device where no functional logic occurs and where the signal line directly connects a port of one component to a port of a higher level component.

17. The at least one program storage device of claim 14, further comprising determining whether the signal name in the next higher level component identified by the locating is a port signal of a further higher level component from the next higher level component, and if so, repeating the automatically checking, and the locating employing the port signal of the next higher level component as the component port name to be searched.

18. The at least one program storage device of claim 14, further comprising determining whether the component having the component port name to be searched is a component at a top most level of the hierarchically-connected components of the device, and if so, indicating that the component port name to be searched is or is connected to a top most level component port of the device and discontinuing the automatically checking, the locating and the outputting for the component port name to be searched.

19. The at least one program storage device of claim 14, wherein the method is implemented within a computer processing tool coupled to a debugging tool or waveform viewing tool, and wherein the receiving comprises receiving the component port name to be searched at the computer processing tool via the debugging tool or waveform viewing tool.

20. The at least one program storage device of claim 19, wherein the component port name to be searched is selected by a user of the debugging tool or waveform viewing tool.
